(19) United States
(12) Patent Application Publication
(10) Pub. No.: US 2019/0126913 A1
(43) Pub. Date: May 2, 2019

(54) SETTING ASSIST SYSTEM OF STRADDLE VEHICLE

(71) Applicant: KAWASAKI JUKOGYO KABUSHIKI KAISHA, Kobe-shi, Hyogo (JP)

(72) Inventors: Masanori Kinuhata, Kobe-shi, Hyogo (JP); Masayuki Enomoto, Kobe-shi, Hyogo (JP); Hiroshi Ishii, Kobe-shi, Hyogo (JP)

(21) Appl. No.: 16/090,098

(22) PCT Filed: Mar. 30, 2016
(86) PCT No.: PCT/JP2016/001859

§ 371 Date: Sep. 28, 2018

(51) Int. Cl. B60W 30/02; B62J 99/00; B60W 30/18

(52) U.S. Cl. CPC B60W 30/02; B62J 99/00; B60W 2300/36; B62J 2099/0013; B60W 30/18

(57) ABSTRACT

A setting assist system of a straddle vehicle configured to change a vehicle body setting which relates to a traveling function of a vehicle body, comprises a receiving section which receives driving operation information relating to a driving operation performed by a rider; a learning section which learns a trend of the driving operation performed by the rider, based on the driving operation information received by the receiving section; a creating section which creates setting information relating to the vehicle body setting based on a learning content obtained by learning by the learning section; and an output section which outputs the setting information created by the creating section.

### TECHNICAL FIELD

The present invention relates to a setting assist system of (for) a straddle vehicle configured to change settings of a vehicle body which are associated with a traveling function of the vehicle body.

### BACKGROUND ART

Vehicles such as a motorcycle or an automobile are c of changing settings to change a driving feeling while the vehicles are traveling. With the changed settings, a vehicle behavior is changed during traveling. Patent Literature 1 discloses that an ECU reads out individual information of a person who wishes to use the vehicle and sets a vehicle environment to one which is adapted to this person.

### CITATION LIST

### PATENT LITERATURE

Patent Literature 1: Japanese Laid-Open Patent Application Publication No. 2004-330891

### SUMMARY OF INVENTION

### Technical Problem

In the disclosure of Patent Literature 1, the vehicle environment can be set for each person who wishes to use the vehicle, for example, the rider. However, in some cases, it is difficult to decide the settings in a case where changing the settings results in complex effects. Under the circumstances, there is a need to assist performing the settings in association with the vehicle environment.

In view of the above, an object of the present invention is to provide a setting assist system of (for) a vehicle which is capable of assisting performing vehicle settings for each rider.

### Solution to Problem

According to the present invention, there is provided a setting assist system of (for) a straddle vehicle configured to change a vehicle body setting which relates to a traveling function of a vehicle body, the setting assist system comprising: a receiving section which receives driving operation information relating to a driving operation performed by a rider; a learning section which learns a trend of the driving operation performed by the rider, based on the driving operation information received by the receiving section; a creating section which creates setting information relating to the vehicle body setting based on a learning content obtained by learning by the learning section; and an output section which outputs the setting information created by the creating section.

In accordance with the present invention, the driving operation trend is learned for each rider, and the setting information is created based on the learning content and output. This makes it possible to propose the setting information which reflects the driving operation trend unique to each rider and reflect the setting information in the vehicle body setting. In brief, the setting assist system is able to assist performing the vehicle setting corresponding to each rider.

In accordance with the present invention, in a case where the driving operation information is obtained repeatedly and the learning is repeated, the learning content can be familiarized. The detailed driving operation trend (e.g., habit or taste) of the rider can be learned. The setting information which reflects the detailed driving operation trend can be proposed, or the detailed driving operation trend can be reflected in the vehicle body setting. In this way, the unique setting information according to the preference of each rider can be proposed, or can be reflected in the vehicle body setting.

In the above invention, the receiving section may receive an evaluation command indicating an evaluation for the setting information, the evaluation command being input by the rider, the learning section may learn a trend of the evaluation command for the setting information, and the creating section may create the setting information based on the learning content including the learned trend of the evaluation command.

In accordance with this configuration, the rider can give the evaluation for the setting information to the learning section, and the learning section can learn the trend of the evaluation for the setting information. This makes it possible to create the setting information corresponding to the evaluation and to create the setting information according to the habit or taste of the rider.

In the above invention, the receiving section may receive external information other than the driving operation information, and the creating section may create the setting information based on the learning content and the external information.

In accordance with this configuration, the setting information corresponding to the situation can be created by referring to the external information or the like which is other than the driving operation information.

In the above invention, the vehicle body may be configured to change plural kinds of vehicle body settings, and the creating section may create the setting information relating to each of the plural kinds of vehicle body settings based on the learning content.

In accordance with this configuration, even in a case where the plurality of vehicle body settings mutually affect the feeling of the driving operation, the driving operation trend can be learned and then the plurality of vehicle body settings can be created. By creating the plurality of vehicle body settings simultaneously in this way, the vehicle body behavior corresponding to the habit or taste of the rider can be obtained.

In the above invention, the receiving section may receive a learning command directing learning of the trend of the driving operation performed by the rider, and the learning section may be configured to determine whether or not to perform the learning, in response to the learning command received by the receiving section.

In accordance with this configuration, the rider can make a choice between a case where the learning of the driving operation trend is necessary and a case where the learning of the driving operation trend is unnecessary. In response to this choice, the learning section determines whether or not to perform the learning. This can result in the learning according to the rider's intention.

In the above invention, the setting assist system may further comprise: a detection/notification section which detects a change in the vehicle body setting and notifies the rider of the change.

In accordance with this configuration, the rider is urged to become aware of how the changed vehicle body setting corresponding to the setting information is reflected in the traveling function of the motorcycle. In this way, the rider is urged to become aware of a difference in the traveling behavior caused by changing the vehicle body setting.

In the above invention, the creating section may store the setting information previously created, and create changed information of the setting information, the changed information indicating a change from the setting information previously created, and the output section may output the setting information and the changed information which have been created by the creating section.

In accordance with this configuration, the rider knows the changed item of the setting information and learns how the traveling function is changed according to the changed item.

In the above invention, the setting assist system may further comprise a memory section which stores therein the learning content obtained by the learning section and predetermined identification information so that the learning content corresponds to the predetermined identification information, the receiving section may receive the driving operation information and the identification information, and the learning section may obtain the learning content from the memory section based on the identification information received by the receiving section, and learn the trend of the driving operation performed by the rider, based on the obtained learning content and a sensor signal received by the receiving section.

In accordance with this configuration, even in a case where the rider having the same identification information changes the vehicle, the learning content obtained by the learning in the previous vehicle can be taken over to a new vehicle.

In the above invention, the learning section may be disposed at a location that is distant from the vehicle body, and the receiving section may receive the driving operation information sent from a transmission section which is provided at the vehicle body and is wirelessly communicable.

In accordance with this configuration, the learning section and the creating section which are required to have high processing abilities are disposed at a location that is distant from and outside the vehicle body. In the straddle vehicle, many components are crammed in a narrow space, and the design flexibility of all of the components is not high. For this reason, it is difficult to mount a processor with a high processing ability in the straddle vehicle. In a case where the processor with a high processing ability is mounted at a location outside the vehicle body, which is higher in design flexibility of the components than the straddle vehicle, the design flexibility of the processor which implements the learning section and the creating section can be made high. As a result, the processor with a high processing ability can be used, and thus the learning section and the creating section can be implemented by this processor.

According to the present invention, there is provided a setting assist method of (for) a straddle vehicle configured to change a vehicle body setting which relates to a traveling function of a vehicle body, the setting assist method comprising the steps of: receiving driving operation information relating to a driving operation performed by a rider; learning a trend of the driving operation performed by the rider, based on the driving operation information received in the step of receiving the driving operation information; creating setting information relating to the vehicle body setting based on the trend of the driving operation learned in the step of learning the trend of the driving operation; and outputting to the vehicle body, the setting information created in the step of creating the setting information.

In accordance with the present invention, the driving operation trend is learned for each rider, and the setting information is created based on the learning content and output. This makes it possible to propose the setting information which reflects the driving operation trend unique to each rider and reflect the setting information in the vehicle body setting. In a case where the driving operation information is obtained repeatedly and the learning is repeated, the learning content can be familiarized. The detailed driving operation trend (e.g., habit or taste) of the rider can be learned. The setting information which reflects the detailed driving operation trend can be proposed, or the detailed driving operation trend can be reflected in the vehicle body setting. In this way, the unique setting information according to the preference of each rider can be proposed, or can be reflected in the vehicle body setting.

### ADVANTAGEOUS EFFECTS OF INVENTION

In accordance with the present invention, it is possible to assist performing vehicle settings for each rider.

### BRIEF DESCRIPTION OF DRAWINGS

FIG. 1 is a view showing a setting assist system of a straddle vehicle according to an embodiment of the present invention.

FIG. 2 is a block diagram showing the configuration of a setting assist system according to Embodiment 1.

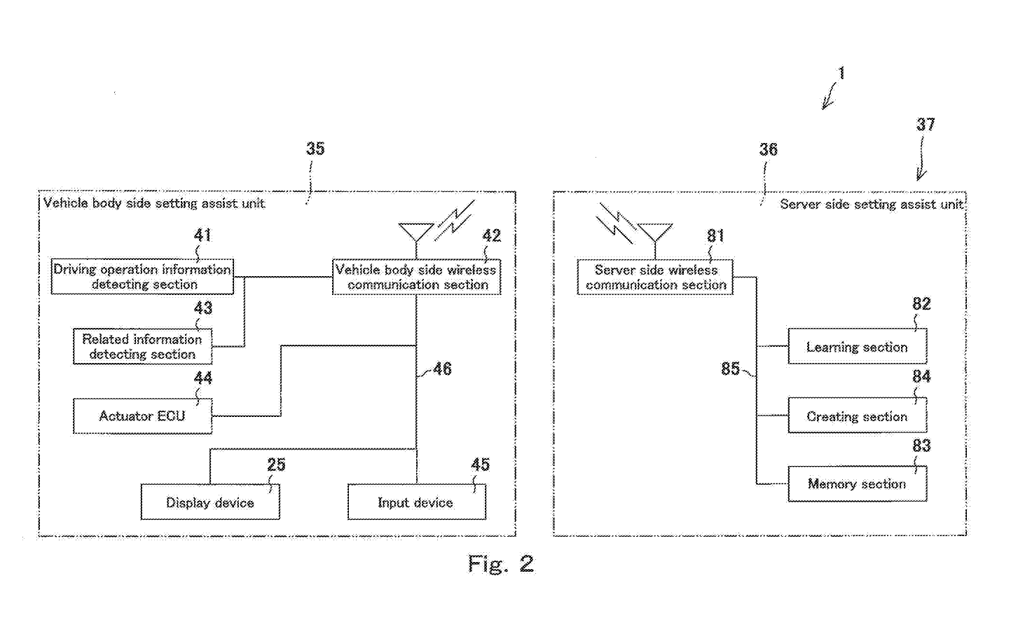

FIG. 3 is a block diagram showing in detail the vehicle body side configuration of the setting assist system of FIG. 2.

FIG. 4 is a flowchart showing a procedure in a case where the setting assist system performs assist processing.

FIG. 5 is a block diagram showing the configuration of a setting assist system according to Embodiment 2.

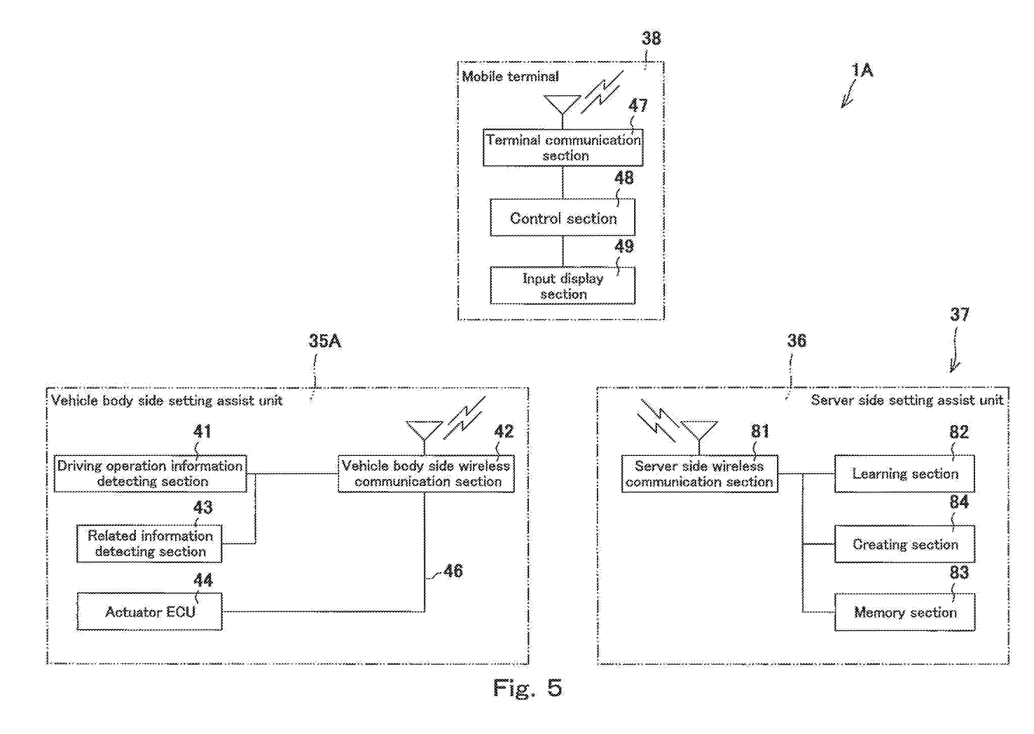

FIG. 6 is a block diagram showing the configuration of a setting assist system according to Embodiment 3.

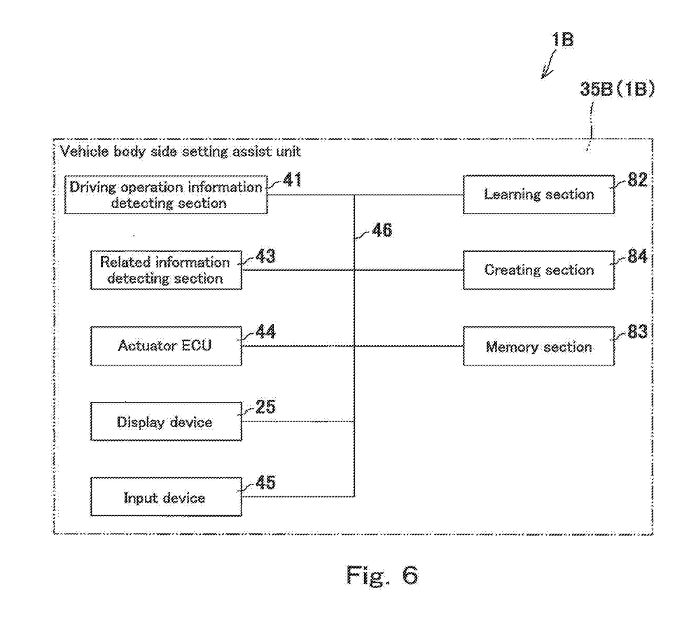

FIG. 7 is a block diagram showing the configuration of a setting assist system according to another embodiment.

### DESCRIPTION OF EMBODIMENTS

Hereinafter, a setting assist system 1 according to the present invention will be described with reference to the drawings. The stated directions are defined for easier understanding of the description, and are not intended to limit the directions or the like of constituents of the invention. The setting assist system 1 described below is merely an embodiment of the present invention. Therefore, the present invention is not limited to the embodiment, and addition, deletion and modification are allowable within the scope of the invention.

Straddle vehicles such as a motorcycle and an all terrain vehicle (ATV) are configured to be capable of changing vehicle settings (engine power, damping forces of suspensions, or the like which will be described later) to change a driving feeling during traveling. By changing the vehicle settings, a vehicle behavior is changed during traveling. In some cases, a rider R changes the vehicle settings to obtain a desired vehicle behavior. To obtain the desired vehicle behavior, it is sometimes necessary to change a plurality of vehicle settings, because the desired vehicle behavior cannot be obtained in a case where one vehicle setting is changed. To address such a situation, the straddle vehicle utilizes setting assist systems 1, 1A, 1B which assist choosing the vehicle settings to obtain the desired vehicle behavior. Hereinafter, the configuration of a motorcycle 2 which is an example of a straddle vehicle will be described, and then the setting assist system 1 will be described.

<Motorcycle>

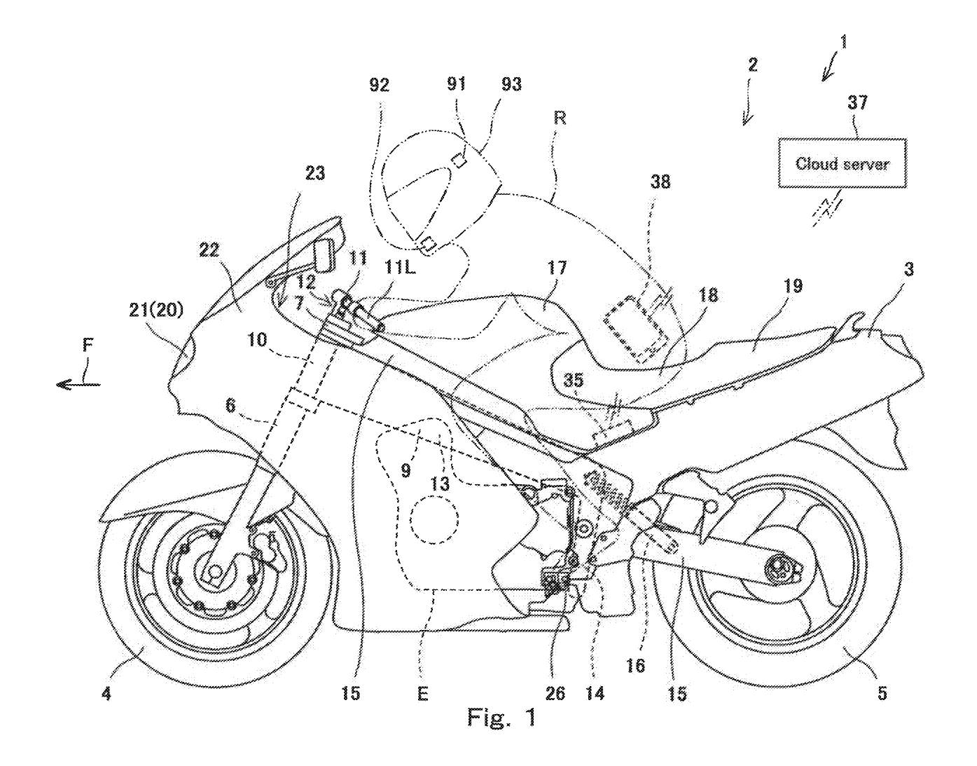

As shown in FIG. 1, a motorcycle 2 includes a vehicle body 3, a front wheel 4, and a rear wheel 5. The front wheel 4 and the rear wheel 5 are rotatably supported by the vehicle body 3. The front wheel 4 is provided with a pair of front suspensions 6 extending obliquely upward from the front wheel 4. Brackets 7 are provided between the pair of front suspensions 6 to connect the front suspensions 6 to each other. A steering shaft (not shown) is provided between the brackets 7 to connect the brackets 7 to each other, and extends substantially in parallel with the front suspensions 6. The steering shaft is rotatably inserted into a head pipe 10 of a vehicle body frame 9.

The brackets 7 are provided with a handle stem 12. A single handle bar 11 is attached on the handle stem 12. Handle grips 11L are provided at right and left end portions, respectively, of the handle bar 11. The handle grips can be gripped with the rider R's hands. The rider R grips the handle grips 11L and rotates the handle bar 11. In this way, the rider can steer the front wheel 4 in a desired direction. The vehicle body 3 includes a steering damper 34. The steering damper 34 can change a damper resistance in steering of the handle bar 11. The head pipe 10 is integrally provided with a pair of right and left main frames 13.

The pair of right and left main frames 13 extend rearward from the head pipe 10. A pair of right and left pivot frames 14 are connected to the rear end portions of the main frames 13, respectively. The front end portions of a swing arm 15 are mounted on the pivot frames 14 such that the swing arm 15 is rotatable. The rear wheel 5 is rotatably mounted on the rear end portion of the swing arm 15. A rear suspension 16 is provided between the swing arm 15 and the main frame 13 to connect the swing arm 15 to the main frame 13. The rear suspension 16 is configured to absorb unevenness of a road surface on which the front wheel 4 and the rear wheel 5 travel, together with the pair of front suspensions 6.

At a location that is rearward of the head pipe 10, a fuel tank 17 is mounted over the pair of main frames 13. At a location that is rearward of the fuel tank 17, a rider seat 18 and a rear seat 19 for a passenger are provided. At a location that is below the fuel tank 17 and between the front wheel 4 and the rear wheel 5, an engine E is supported by the main frames 13 and the pivot frames 14. A throttle device 31 and an air cleaner are connected to the engine E. The engine E is configured to take in air from outside via the air cleaner and the throttle device 31. The throttle device 31 is configured to control opening/closing (to be specific, amount of intake air) of a throttle valve according to the amount of a rotation of a throttle grip which is rotatably attached on the left handle grip 11L. The engine E includes a fuel injection device 32 and an ignition device 33. The engine E is configured to take in fuel injected from the fuel injection device 32 into a cylinder together with the air, to ignite an air-fuel mixture of the fuel and the air, by the ignition device 33, combust the air-fuel mixture, and rotate a crankshaft.

A transmission device is connected to the crankshaft of the engine E. The transmission device is configured to transmit driving power output from the crankshaft of the engine E to the rear wheel 5 through a chain. The transmission device includes a clutch mechanism and a multi-stage transmission. The clutch mechanism is actuated in response to an operation of a clutch lever (not shown) disposed in front of the left handle grip 11L to cut off a driving power transmission path between the engine E and the rear wheel 5. The multi-stage transmission is configured to reduce the driving power of the engine E and transmit the reduced driving power to the rear wheel 5. By changing a gear position in this way, a transmission gear ratio is shifted.

The rear wheel 5 and the front wheel 4 are provided with brake mechanisms, respectively (not shown). The vehicle body 3 includes a brake lever (not shown) and a brake pedal (not shown) to activate the brake mechanisms. The brake lever is disposed in front of the right handle grip (not shown). The rider R pulls the brake lever toward the rider with the right hand to activate the brake mechanism for the front wheel 4. The brake pedal is disposed at the right foot of the rider R riding the motorcycle 2. The rider R presses down (depresses) the brake pedal to activate the brake mechanism for the rear wheel 5.

A head lamp unit 20 is disposed forward F of the handle bar 11. A meter device 23 is attached on a front cowling 22. The meter device 23 includes gauges and a display device 25 which will be described later. The meter device 23 is disposed forward of the handle bar 11. The gauges are configured to display a vehicle speed, an engine speed, an oil temperature, and the like. The display device 25 is configured to display information other than the information displayed on the gauges.

The motorcycle 2 configured as described above is capable of changing settings of components (constituents) such as the pair of front suspensions 6, the rear suspension 16, the throttle device 31, the fuel injection device 32, and the ignition device 33, i.e., vehicle body settings. The vehicle body settings are defined as, for example, settings which affect a traveling behavior, of the component (constituent) settings. By changing the vehicle body settings, the vehicle behavior is changed during traveling. For example, the vehicle body settings include settings associated with the power behavior of the engine E such as control parameters of the engine E and settings associated with the traveling behavior of the vehicle body 3. The settings associated with the power behavior of the engine E include, for example, a map of a traction control, a power map of the engine E, a map of a power reduction of the engine E, and operation conditions of idling stop. The settings associated with the traveling behavior of the vehicle body 3 include the settings of the suspensions 6, 16 (initial loads, damping forces, spring rates, stroke lengths, etc.), a damping force and operation of the steering damper 34, geometries (e.g., a caster angle, a vehicle height, a pivot position) of the vehicle body 3, and operations of electronic control devices (brake system 77, AFS80, and the like).

TABLE 1
Vehicle body settings

| | |
|---|---|
| Power behavior of engine E | Traveling behavior of vehicle body 3 |
| Map of traction control | Settings of suspensions 6, 16 |
| Power map of engine E | (initial loads, damping forces, |
| Map of power reduction | spring rates, stroke lengths, etc.) |
| of engine E | Damping force and |
| Operation conditions of | operation of steering |
| idling stop. | damper 34 (e.g., caster angle, |
| | vehicle height pivot position) |
| | Operations of electronic |
| | control devices 77, 78, 80 |

Typically, the motorcycle 2 configured as described above has the following features. The motorcycle 2 is lightweight. A grounding area of the motorcycle 2 with respect to a road surface is small. The vehicle body 3 is required to be banked while the vehicle body 3 is turning. A distance between the front and rear wheels 4, 5 is short. A pitch operation tends to occur. For these reasons, the traveling behavior of the motorcycle 2 is more significantly affected by changing the vehicle body settings than an automobile which has a relatively large weight and is less affected by rolling and pitching. Setting items to be changed do not always correspond to the traveling behaviors of the motorcycle 2 of the rider R, respectively, in a one-to-one correspondence. To obtain a desired traveling behavior of the motorcycle 2, it is sometimes necessary to change plural items. In a case where changing the settings result in complicated effects, how the traveling behavior of the motorcycle 2 is changed by changing the settings mostly depends on an empirical rule. Unless the rider is experienced, it may be sometimes difficult for the rider to decide the settings to change the traveling behavior of the motorcycle 2 into a desired behavior. In view of the above-described circumstances, the motorcycle 2 is equipped with a setting assist system 1 which is a system for assisting changing the vehicle body settings.

<Setting Assist System>

The setting assist system 1 is a system used to change the vehicle body settings during traveling of the motorcycle 2. The setting assist system 1 includes a vehicle body side setting assist unit 35 and a server side setting assist unit 36. The setting assist system 1 is not limited to a setting assist system which changes the vehicle body settings during traveling, and may be a setting assist system which changes the vehicle body settings while the motorcycle 2 is stopped. The vehicle body side setting assist unit 35 is mounted in the vehicle body 3. The server side setting assist unit 36 is implemented by a server such as a cloud server 37, located at a distance from the vehicle body 3. The cloud server 37 is a server constructed on a cloud which can be accessed by various clients via Internet. The vehicle body side setting assist unit 35 includes a driving operation information detecting section 41, a vehicle body side wireless communication section 42, a related information detecting section 43, an actuator ECU 44, an input device 45, and a display device 25.

The driving operation information detecting section 41 has a function of detecting operation information (namely, driving operation information) relating to the driving operation performed by the rider R who drives the motorcycle 2. Specifically, the driving operation information detecting section 41 detects driving operation information relating to operation (manipulation) members (accelerator grip, brake lever, or the like) to be operated (manipulated) by the rider so that the rider R drives the motorcycle 2. The driving operation information detecting section 41 may indirectly detect the driving operation information by detecting information relating to a vehicle state which changes in response to the rider R's operation of the operation member. The motorcycle 2 can be steered by shifting the body weight of the rider R during a turn. Therefore, shifting the rider R's body weight and the associated change in the vehicle state may be detected as the driving operation information.

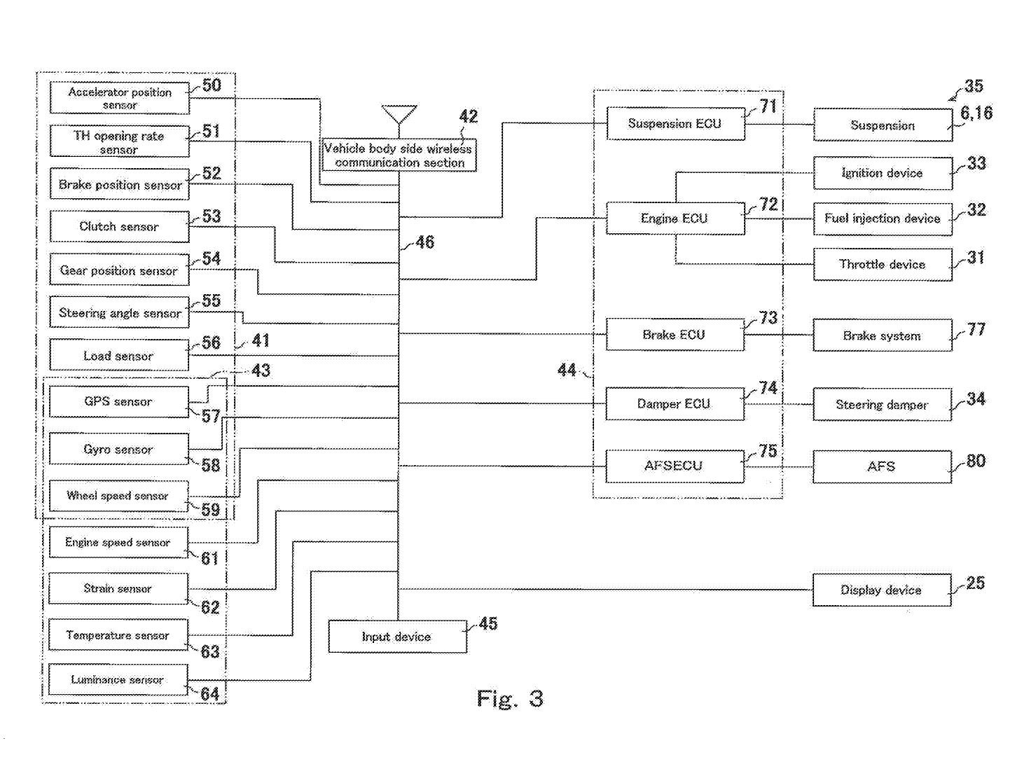

The driving operation information detecting section 41 with the above-described function includes a plurality of sensors. As shown in FIG. 3, in the present embodiment, the driving operation information detecting section 41 includes sensors 50 to 59 described below. The accelerator position sensor 50 is, for example, an angular displacement sensor which detects a rotation amount of the throttle grip. The throttle opening rate sensor (TH opening rate sensor) 51 is, for example, an angular displacement sensor which detects the opening rate (opening degree) of the throttle valve included in the throttle device 31.

The brake position sensor 52 is, for example, a position sensor which detects a position of the brake lever and a position of the brake pedal. The clutch sensor 53 is, for example, a position sensor, which detects whether or not the clutch lever has been operated (operation/non-operation of the clutch lever). The gear position sensor 54 is, for example, an angular displacement sensor which is attached on a shift drum of a multi-stage transmission to detect a transmission gear position. The steering angle sensor 55 is, for example, an angular displacement sensor which detects a rotation angle of the steering shaft with respect to the head pipe 10, i.e., a steering angle of the front wheel 4.

The load sensors 56 are attached on the rider seat 18, the rear seat 19, and right and left foot steps 26, respectively, to detect the body weight of the rider R, the body of the passenger, and a ratio of a load between the right side and the left side in a case where the rider R shifts the body weight. The GPS sensor 57 is configured to detect a present position of the motorcycle 2. The gyro sensor 58 is configured to detect acceleration rates, speeds or angular displacements around three axes which are orthogonal to each other, of the vehicle body 3. In the present embodiment, the gyro sensor 58 is configured to detect the acceleration rates in three-axis directions, for example, a roll angle, a pitch angle, and a yawing angle of the vehicle body 3. The wheel speed sensor 59 is, for example, an angular displacement sensor which detects wheel speeds which are the rotation speed of the front wheel 4 and the rotation speed of the rear wheel 5.

TABLE 2
Driving operation information
Rotation amount of throttle grip (accelerator position sensor 50)
Throttle valve opening rate (TH opening rate sensor 51)
Position of brake lever and position of brake
pedal (brake position sensor 52)
Operation/non-operation of clutch lever (clutch sensor 53)
Transmission gear position (gear position sensor 54)
Steering angle of front wheel 4 (steering angle sensor 55)
Body weight of rider R (load sensor 56)
Body weight of passenger (load sensor 56)
Ratio of load between left side and right side in a case where rider
R shifts body weight (load sensor 56)
Present position of motorcycle 2 (GPS sensor 57)
Rolle angle, pitch angle, and yawing angle of
vehicle body 3 (gyro sensor 58)
Rotation speed of front wheel 4 and rotation speed of
rear wheel 5 (wheel speed sensor 59)

As described above, the sensors 50 to 59 are configured to directly or indirectly detect the driving operation information. The sensors 50 to 59 are directly or indirectly connected to the vehicle body side wireless communication section 42 via, for example, a bus 46 to send (transmit) the driving operation information to the vehicle body side wireless communication section 42. The related information detecting section 43 is connected to the vehicle body side wireless communication section 42.

The related information detecting section 43 has a function of detecting external information other than the driving operation information, for example, related information relating to the driving operation. The related information detecting section 43 is configured to detect, for example, information of an environment surrounding the motorcycle 2. The environment information surrounding the motorcycle 2 includes, for example, traveling areas (flat land, mountain road, road surface slope, traveling country, etc.), traveling roads (high-speed road, urban area, circuit, etc.), paved states of the traveling road (asphalt, stone pavement, sand soil, etc.), a history of the traveling road, traveling time (traveling day, traveling time period, day of week of traveling, traveling season, etc.), ambient temperature, weathers (clear weather, rainy weather, cloudy weather, weather forecast, ambient luminance, etc.), and traffic states. Alternatively, the related information may include other information assumed as affecting the driving operation, for example, component information of components equipped in the motorcycle 2, riding information of persons (rider R and passenger), the traveling speed, the engine speed, or the like. Note that the environment information surrounding the motorcycle 2 does not always include all of these information.

The related information detecting section 43 with the above-described function includes a plurality of sensors. In the present embodiment, the related information detecting section 43 includes sensors 61 to 64. The engine speed sensor 61 is configured to detect the engine speed of the engine E, specifically, the rotation speed of the crankshaft. The strain sensor 62 is configured to detect a strain amount around an axis line of the steering shaft to detect torque exerted on the steering shaft, namely, steering torque. The temperature sensor 63 is configured to detect the ambient temperature of the vehicle body 3. The luminance sensor 64 is configured to detect brightness (luminance) in a region surrounding the vehicle body 3. The GPS sensor 57 is also included in the related information detecting section 43 to detect the traveling area, the traveling road, the traveling history, or the like. Likewise, the gyro sensor 58 is also included in the related information detecting section 43 to detect the road slope, and the wheel speed sensor 59 is also included in the related information detecting section 43 to detect the traveling road, the traveling time, or the like. Alternatively, the load sensor 56 may be included in the related information detecting section 43 and the body weight of the rider R and the body weight of the passenger may be handled as the related information. Further, the related information detecting section 43 obtains the ambient temperature, the weather, the traffic state, and predicted information of these via Internet, in addition to from the sensors 61 to 64, 57 to 59.

TABLE 3
Related information
Traveling area (GPS sensor 57, gyro sensor 58)
Traveling road and paved state of traveling road (GPS sensor 57)
History of traveling road and traveling time (engine speed sensor 61)
Ambient temperature (temperature sensor 63)
Weather, traffic state, etc. (Internet)

The sensors 57 to 59, 61 to 64 are configured to detect the relating information which is not directly related to the driving operation and may be associated with or affect the driving operation. The sensors 59 to 59, 61 to 64 are connected to the vehicle body side wireless communication section 42 and configured to send the related information to the vehicle body side wireless communication section 42. The actuator ECU 44 is connected to the vehicle body side wireless communication section 42, in addition to the two detecting sections 41, 43.

The actuator ECU 44 includes an ECU which changes the vehicle body settings to change the traveling function of the vehicle body 3. In the present embodiment, the following ECUs 71 to 75 are included in the actuator ECU 44. The suspension ECU 71 is connected to the pair of front suspensions 6 and the rear suspension 16. The pair of front suspensions 6 and the rear suspension 16 is electronically-controlled suspensions. Each of the front suspensions 6 and the rear suspension 16 are configured to change settings of an initial load of a spring, a damping force of an absorber, a spring rate, a stroke length, or the like. The suspension ECU 71 is configured to change the settings of the pair of front suspensions 6 and the rear suspension 16, based on setting information which will be described later. The engine ECU 72 is connected to the throttle device 31, the fuel injection device 32, and the ignition device 33, and is configured to control the operations of the devices 31 to 33. The engine ECU 72 is configured to change the settings of the opening rate amount of the throttle device 31, the amount of fuel injected by the fuel injection device 32, the ignition timing of the ignition device 33, or the like, based on the setting information which will be described later.

The brake ECU 73 is connected to the brake system 77. The brake system 77 is a device which controls the operation of the brake mechanism. The brake system 77 has an ABS function and a CBS function. Specifically, in a case where the brake mechanism is activated, the brake system 77 controls the operation of the brake mechanism and adjusts a braking force so that the front wheel 4 and the rear wheel 5 are not locked (ABS function). The brake system 77 is configured to activate both of the front brake mechanism and the rear brake mechanism in response to the operation of the brake lever and properly allocate the braking forces to the brake mechanisms (CBS). The brake ECU 73 is configured to control the motion of the brake system 77, and change the settings such as activation (initiation) timing of the ABS function and allocation amount in the CBS function, based on the setting information which will be described later.

The damper ECU 74 is connected to the steering damper 34. The steering damper 34 is an electronically-controlled damper and is configured to change the damping force. The damper ECU 74 is configured to change the setting (damping force) of the steering damper 34 based on the setting information which will be described later. The AFSECU 75 is connected to an adaptive front-lighting system (AFS) 80. The AFS 80 is a device which changes an emission direction of the head lamp 21 based on a bank angle of the vehicle body 3 or a steering angle. The AFSECU 75 is configured to control the motion of the AFS80 and change the settings such as the activation initiation condition or emission condition of the AFS 80 in response to a command.

As described above, the ECUs 71 to 75 are configured to control the motions of the components and change the settings. The ECUs 71 to 75 with the above-described configuration are connected to the vehicle body side wireless communication section 42 via a bus 85 and is configured to change the vehicle body settings based on the setting information sent (transmitted) via the vehicle body side wireless communication section 42. The input device 45 and the display device 25 are connected to the vehicle body side wireless communication section 42, in addition to the driving operation information detecting section 41, the related information detecting section 43 and the actuator ECU 44.

The input device 45 is a device which can be operated by the rider R to input various information. The display device 25 is a device which displays the various information to be seen by the rider R. For example, the display device 25 is configured to display questions, changed setting information, or the like in response to a command from the vehicle body side wireless communication section 42. The input device 45 is used to input “YES”, “NO” or the like to the information displayed on the display device 25. Note that the input device 45 is not limited to a device operated by the rider R to input a command, for example, a switch, and may be a brain wave sensor built in a helmet or the like. Further, evaluation may be obtained based on perspiration or heartbeat of the rider R.

The input information is sent (transmitted) from the input device 45 to the vehicle body side wireless communication section 42. The vehicle body side wireless communication section 42 is communicable with the server side setting assist unit 36 via a base station which is not shown. Specifically, the vehicle body side wireless communication section 42 is configured to wirelessly send (transmit) the information sent from the driving operation information detecting section 41, the related information detecting section 43, and the input device 45 to the server side setting assist unit 36. The vehicle body side wireless communication section 42 is configured to receive the information wirelessly sent from the server side setting assist unit 36, and send this information to the bus 46 so that the actuator ECU 44 and the display device 25 obtain this information. In this way, the vehicle body side setting assist unit 35 is configured to wirelessly send (transmit) and receive the information to and from the server side setting assist unit 36 via the vehicle body side wireless communication section 42.

The server side setting assist unit 36 includes a server side wireless communication section 81 to wirelessly send (transmit) and receive the information to and from the vehicle body side wireless communication section 42. In addition, the server side setting assist unit 36 includes a learning section 82, a memory section 83, and a creating section 84 to process the received information. The learning section 82, the creating section 84 and the memory section 83 are connected to each other to communicate the information. The learning section 82, the memory section 83, and the creating section 84 are also connected to the server side wireless communication section 81 and configured to obtain the information sent from the vehicle body side setting assist unit 35. The learning section 82 is configured to obtain the driving operation information and the input operation which have been obtained by and sent from the vehicle body side setting assist unit 35. The learning section 82 is configured to learn a trend of the driving operation (driving trend) performed by the rider R based on these information.

For example, the learning section 82 is configured to learn a trend of an accelerator work performed by the rider R based on the information (throttle opening rate) received from the TH opening rate sensor 51. Specifically, the learning section 82 is configured to learn whether the rider R desires rapid acceleration or slow acceleration. The learning section 82 is configured to learn a detailed trend of the driving operation performed by the rider R based on a plurality of detection signals, as well as one detection signal. For example, the learning section 82 is configured to learn different accelerator works during straight-ahead traveling and curved traveling, i.e., the trend of the accelerator work during each traveling, based on the information received from the TH opening rate sensor 51 and the information (bank angle) of the roll angle received from the gyro sensor 58. In the same manner, the learning section 82 is configured to learn the trends of various items of the driving operation performed by the rider R based on the driving operation information detected by the sensors 51 to 59. The learning section 82 is configured to learn the trend of the driving operation performed by the rider R based on answers to questions (100 questions) which are made to the rider R in advance before the setting information is output, the answers being input by the input device 45. The questions may be displayed on the display device 25 one by one. Or, the questions may be written in paper and the rider may input the answers by use of the input device 45 while seeing the questions. The input answers are sent from the input device 45 to the learning section 82. As examples of the items of the driving operation trend, there are a trend of a braking operation, a trend of a clutch operation, a trend of a transmission shifting operation, a trend of a handle operation, a trend of shifting of the body weight, and a trend of a slip ratio.

TABLE 4
Driving operation trends

| | |
|---|---|
| Trend of brake operation | Trend of clutch operation |
| Trend of transmission shifting operation | Trend of handle operation |
| Trend of shifting body weight | Trend of slip ratio |

Questions
Age
Body length
Body weight
Driving history
Desired operation trend
Time period for which rider mainly drives

For example, the learning section 82 learns the trend of the brake operation based on the information (e.g., position) received from the brake position sensor 52, and learns the trend of the clutch operation based on the information (information as to operation/non-operation of the clutch) received from the clutch sensor 53. The learning section 82 learns the trend of the transmission shifting operation from the information (transmission gear position) received from the gear position sensor 54. The learning section 82 learns the trend of the handle operation based on the information (steering angle) received from the steering angle sensor 55 and the information (vehicular swept path) received from the GPS sensor 57. The learning section 82 learns the trend of shifting the body weight based on the information (bank angle) received from the gyro sensor 58. The learning section 82 learns the trend of the slip ratio based the information (wheel speeds of the front and rear wheels 4, 5) received from the wheel speed sensor 59.

As described above, the learning section 82 is configured to learn the driving operation trends of various items based on the driving operation information. In addition, the learning section 82 obtains various information used for the learning based on the related information. For example, the learning section 82 obtains vehicle speeds (instantaneous vehicle speed, average traveling speed, maximum speed, speed distribution during traveling), and the acceleration rate of the motorcycle 2 based on the information received from the wheel speed sensor 59. The learning section 82 obtains the bank state, the pitch state and the slope of the traveling road (sloping road, flat road) based on the information received from the gyro sensor 58. Further, the learning section 82 obtains the vehicular swept path and a distance between forward and backward cars based on the information received from the GPS sensor 57. The learning section 82 obtains the width and road state (off-road, on-road, stone pavement, etc.) of the traveling road based on the information received from the GPS sensor 57 and map information stored in the memory section 83 which will be described later. The phrase “the learning section 82 obtains the information” means that the learning section 82 performs calculation based on the related information as well as receiving the information from other sensors or functional constituents such as the ECUs.

The learning section 82 learns the driving operation trend in view of the obtained information and the external information including the related information. For example, the learning section 82 learns the detailed items of the driving operation trend (specifically, the learning section 82 learns the driving operation trend corresponding to the traveling speed zone, brightness or weather). The plurality of items of the driving operation trend learned in this way are stored in the memory section 83 as learning contents together with the process of the learning.

The memory section 83 contains the learning contents therein so that the learning contents correspond to identification information allocated to each vehicle body 3 or each rider R. A large quantity of learning contents and much identification information are stored in the memory section 83 so that the learning contents correspond to the identification information. For this reason, the identification information is attached to the information sent from the vehicle body side setting assist unit 35. Receiving each information attached with the identification information, the learning section 82 obtains the learning content corresponding to this identification information from the memory section 83, and re-learns the driving operation trend based on this learning content and the various information (driving operation information and external information). The driving operation trends obtained by the re-learning and the associated learning processes are stored in the memory section 83 as the learning contents. The memory section 83 contains therein setting rules defining setting information to be created for the learning contents. The learning contents and the setting rules are used to create the setting information by the creating section 84.

The creating section 84 creates the setting information relating to the vehicle body settings based on the learning contents (driving operation trends) and the setting rules which are stored in the memory section 83. For example, in a case where the learning section 82 learns that the rider tends to drive on the paved road at a high vehicle speed, the creating section 84 creates the setting information which increases the damping forces of the suspensions 6, 16 based on the setting rule. In contrast, in a case where the learning section 82 learns that the rider R tends to drive on an uneven road with bumps such as the stone pavement at a low vehicle speed, the creating section 84 creates the setting information which decreases the damping forces of the suspensions 6, 16 based on the setting rule. In a case where the learning section 82 learns that the rider R is a large-sized person, or tends to perform tandem traveling, the creating section 84 increases the initial loads of the suspensions 6, 16 and creates the setting information which increases the damping forces of the suspensions 6, 16, based on the setting rules. In the same manner, the creating section 84 creates the setting information corresponding to the component(s) (constituent(s)) (at least one of the throttle device 31, the fuel injection device 32, the ignition device 33, the break system 77, the steering damper 34, and the AFS 80) of the vehicle body 3 based on the items of driving operation trend stored in the memory section 83. The created setting information is stored in the memory section 83. Note that the creating section 84 creates the setting information based on the learning content corresponding to the identification information which matches the identification information attached to the information sent (transmitted) from the vehicle body side setting assist unit 35.

This will be described in more detail. The creating section 84 creates the setting information based on the setting rules as described below. Regarding the setting rule for the suspensions 6, 16, the damping forces of the suspensions 6, 16 are decreased in a case where the range of the traveling speed during traveling is low, and are increased in a case where the range of the traveling speed during traveling is high. The initial load of the front suspension 6 is set to a value in a predetermined range according to an insufficient sagging or an excessive sagging of the suspension 6 in response to the braking operation, the pitching during the braking, strong or weak breaking, etc. while the motorcycle 2 is entering a corner.

The damping force of the front suspension 6 is set to a value in a predetermined range based on a primary turn operation trend of the front side of the motorcycle 2. The tension damping force of the front suspension 6 is set depending on a dynamic posture change or the like of the vehicle body 3 which is associated with a throttle operation. The damping force of the rear suspension 16 is set to a value in a predetermined range based on a secondary turn operation trend of the rear side of the motorcycle 2. The tension damping force of the rear suspension 16 is set depending on the road state. The compression damping force of the rear suspension 16 is set depending on the traveling history (e.g., frequent cornering at medium to high speeds), the weather (e.g., clean weather, or rainy weather), or the like. In particular, in the rainy weather, the damping force is reduced and the motorcycle 2 is less likely to slide. The initial load of the rear suspension 16 is set to a value in a predetermined range depending on an accelerator work performed while the motorcycle 2 is exiting the corner, and an insufficient sagging and an excessive sagging during acceleration.

The setting rules are defined so that the initial loads of the suspensions 6, 16 which are set in the above-described manner are associated with each other, and the damping forces of the suspensions 6, 16 which are set in the above-described manner are associated with each other. The setting rules are defined so that the tension damping forces are associated with each other, and the compression damping forces are associated with each other. Further, each of the initial loads and the damping forces of the suspensions 6, 16 may be set to a larger value (or a smaller value) in the predetermined range according to the setting rules, and may be changed according to the evaluation of the rider R.

The setting rule for the pivot position of the swing arm 15 is changed depending on the traveling road. In the case of the circuit, the pivot position is set so that the height of the rear part of the motorcycle 2 is increased to secure the bank angle or easily perform a turn. According to this setting, the pivot position is lowered by a variable pivot. The setting rule for the caster angle is defined so that the caster angle is set to a larger value in a case where high-speed traveling and straight-ahead traveling continue, and is set to a smaller value in a case where a steering amount is larger and a rapid steering operation is performed. The setting rule for a pneumatic pressure of a tire is defined so that the pneumatic pressure is set higher in a case where the high-speed traveling and straight-ahead traveling continue, and is set lower in a case where the motorcycle 2 travels on the uneven road.

The setting rule for the steering damper 34 is defined so that the damping force of the steering damper 34 is increased in a case where high-speed traveling and straight-ahead traveling continue, and a case where the motorcycle 2 travels on the uneven road. On the other hand, the damping force of the steering damper 34 is decreased in a case where the steering amount is large, a case where a rapid steering operation is performed, and a case where the rider R wishes to easily rotate the handle bar 11.

The setting rule of the engine E is defined so that the fuel injection amount or the like is set to reduce a power change in a case where the rider R recognizes fuel efficiency as important rather than power. In contrast, the fuel injection amount or the like is set to output power corresponding to the operation of the rider R in a case where the rider R frequently performs rapid starting and rapid deceleration. A time for which the engine ECU 72 performs a control is set longer or shorter according to the rider R's preference, or settings of the engine E controlled by the engine ECU 72 may be changed according to changes in the vehicle body settings corresponding to the trend during the braking and the trend during the cornering. Further, the power of the engine E may be changed with the changes in the settings of the suspensions 6, 16.

As described above, in the server side setting assist unit 36, the learning section 82 learns the trends of the driving operations performed by the rider R, and the creating section 84 creates the setting information of the components (constituents) of the vehicle body 3 based on the learning contents (learning processes, driving operation trends, and the like) obtained by the learning and the setting rules. The learning section 82 and the creating section 84 with the above-described functions are implemented by performing information processing by use of an artificial intelligence (AI) such as neural network or Watson (registered mark). Receiving the information obtained by the vehicle body side setting assist unit 35, the learning section 82 learns the driving operation trends by the above-described information processing. The creating section 84 initializes the setting rules, and changes the setting rules according to the learning contents obtained repeatedly and evaluation for the proposed setting information which will be described later. In this way, the learning section 82 and the creating section 84 are configured to create the setting information relating to the vehicle body settings while estimating the vehicle body settings according to the rider R's taste and preference. The creating section 84 compares the setting information newly created to the setting information previously stored, and creates changed information indicating a changed item (content). The setting information and the changed information which have been created as described above are transmitted (sent) from the creating section 84 to the server side wireless communication section 81 and wirelessly transmitted (sent) to the vehicle body side setting assist unit 35 via the server side wireless communication section 81.

As shown in FIG. 1, the setting assist system 1 includes a voice output device 91 and a voice input device 92. The voice output device 91 is, for example, a speaker. The voice input device 92 is, for example, a microphone. The voice output device 91 and the voice input device 92 are built in, for example, a helmet 93. The voice output device 91 transmits the information (e.g., the setting information) to the rider R in the form of a voice. The voice input device 92 transmits the rider R's intention in the form of a voice. The voice output device 91 and the voice input device 92 are wirelessly communicable with the vehicle body side wireless communication section 42 of the vehicle body side setting assist unit 35.

In the vehicle body side setting assist unit 35, the display device 25 displays the setting information and the changed information which have been sent from the server side setting assist unit 36, and displays whether or not to permit change to the settings of the components (constituents) based on the setting information. By use of the input device 45, the rider R can give the answer to whether or not to permit the change to the settings, which is displayed on the display device 25. The input answer is sent to the learning section 82 via the vehicle body side wireless communication section 42 and the server side wireless communication section 81. The learning section 82 learns the trend which is the answer (evaluation for the proposed setting information) to whether or not to permit the change to the setting information. The trend of the evaluation is included in the learning content. The creating section 84 creates the setting information based on the learning content including the trend of evaluation.

The input device 45 of the vehicle body side setting assist unit 35 is capable of inputting a learning command directing the learning section 82 to learn the trend of the driving operation. The learning command input by use of the input device 45 is sent from the vehicle body side wireless communication section 42 to the learning section 82 via the server side wireless communication section 81. Receiving the learning command, the learning section 82 begins to learn the driving operation trend and the evaluation trend in the above-described manner, and the creating section 84 creates the setting information based on the trend learned by the learning section 82.

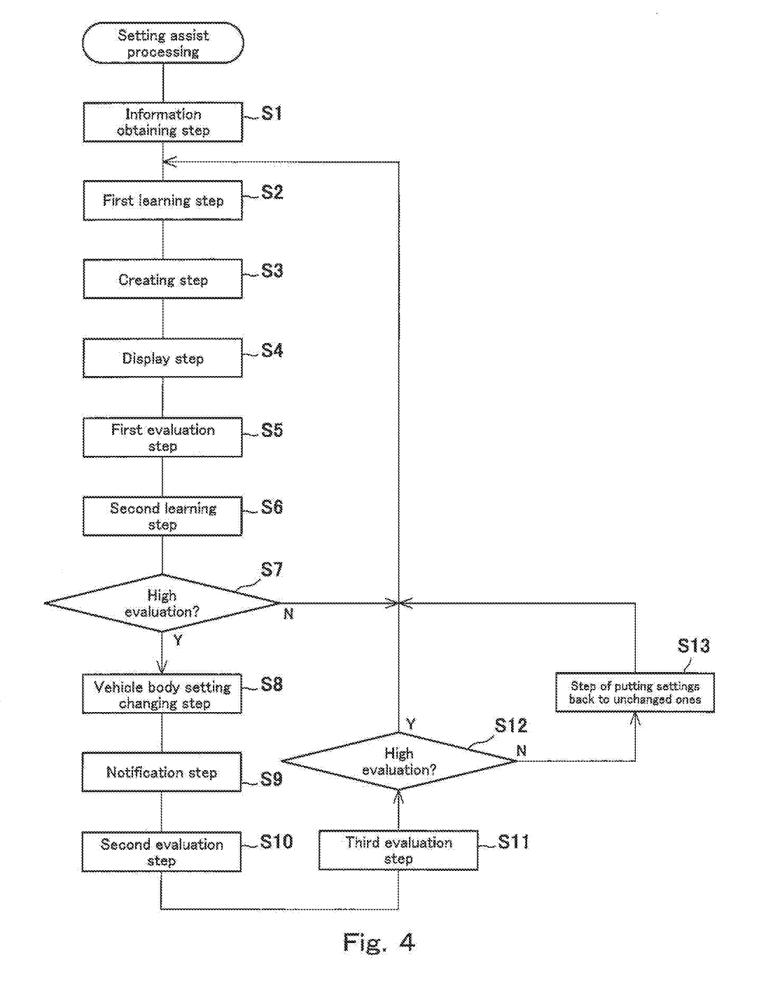

Hereinafter, a procedure (setting assist processing) for creating, displaying or changing the setting information of the vehicle body 3 performed by the setting assist system 1 based on the driving operation information and the external information will be described with reference to a flowchart of FIG. 4. The setting assist system 1 is configured to know the driving operation trends of the rider R before the setting assist processing is initiated. For example, as described above, the display device 25 displays the questions, and the answers to the questions are obtained in advance. For example, the questions include questions related to the rider R's preferences of the vehicle body settings such as desires (demands) for high acceleration, comfortable ride, and well-balanced acceleration and comfortable ride. The rider R gives the answers to the questions by use of the input device 45. Based on the answers to the questions, the setting assist system 1 knows the rider R's tastes and preference, the driving operation trends considered by the rider R. The driving operation trends are stored in the memory section 83. When the rider R inputs the learning command by use of the input device 45, the setting assist system 1 initiates the setting assist processing and moves to step S1.

In step S1 which is an information obtaining step, the learning section 82 obtains from the vehicle body side setting assist unit 35, the driving operation information detected by the sensors 51 to 59 included in the driving operation information detecting section 41 and the related information detected by the sensors 61 to 64 included in the related information detecting section 43, via the two wireless communication sections 42, 81. After the learning section 82 has obtained the driving operation information and the related information, the process moves to step S2.

In step S2 which is a first learning step, the learning section 82 learns the driving operation trends of the rider R based on the obtained driving operation information, with reference to the driving operation trends stored in the memory section 83. For example, the learning section 82 learns the trend of the rider R's accelerator work based on the throttle opening rate received from the TH opening rate sensor 51, and learns the trends of the accelerator works corresponding to the straight-ahead traveling and curved traveling, based on the throttle opening rate received from the TH opening rate sensor 51 and the bank angle received from the gyro sensor 58. The learning section 82 learns the detailed items of the driving operation trend based on the external information. Specifically, the learning section 82 divides the driving operation trend into detailed items based on the information (brightness/darkness) received from the luminance sensor 64 and learns the trend of the accelerator work corresponding to each brightness. Also, the learning section 82 divides the driving operation trend into detailed items based on the information received from the temperature sensor 63 and learns the trend of the accelerator work corresponding to each temperature zone. The learning section 82 learns the driving operation trends in this way. The learning contents are stored in the memory section 83. After that, the process moves to step S3.

In step S3 which is a creating step, the creating section 84 creates the setting information relating to the vehicle body settings based on the learning contents obtained by the learning by the learning section 82 in step S2. For example, in a case where the accelerator work is slow as the trend of the accelerator work of the rider R, the creating section 84 determines that the rider R does not desire a high acceleration force and creates the setting information which reduces the opening/closing amount of the throttle valve of the throttle device 31 with respect to a rotation amount of the throttle grip. On the other hand, in a case where the accelerator work is quick as the trend of the accelerator work of the rider R, the creating section 84 creates the setting information which increases the opening/closing amount of the throttle valve of the throttle device 31 with respect to a rotation amount of the throttle grip so that a higher acceleration force is obtained. In a case where the driving operation trend is divided into detailed items according to the external information, for example, brightness, the creating section 84 creates the setting information based on the corresponding driving operation trend based on the obtained related information. For example, in a case where the creating section 84 determines that it is bright, based on the information received from the luminance sensor 64, the creating section 84 creates the setting information based on the trend of the accelerator work corresponding to a bright state. On the other hand, in a case where the creating section 84 determines that it is dark, based on the information received from the luminance sensor 64, the creating section 84 creates the setting information based on the trend of the accelerator work corresponding to a dark state. Thus, in a case where the driving operation trend is divided into detailed items based on the external information, the creating section 84 obtains the external information and creates the setting information based on the obtained external information. The created setting information is stored in the memory section 83. The creating section 84 compares the created setting information to the previously stored setting information, creates changed information indicating the change, and stores the changed information in the memory section 83. After the setting information and the changed information have been created, the process moves to step S4.

In step S4 which is a display step, the setting information and the changed information which have been created by the creating section 84 are sent from the server side wireless communication section 81 to the vehicle body side wireless communication section 42. The display device 25 receives the setting information and the changed information and displays them. In addition, the display device 25 displays whether or not to permit the change to the settings (vehicle body settings) of the components (constituents) of the vehicle body 3 based on the setting information so that the rider R inputs the answer by use of the input device 45. The display device 25 does not necessarily display whether or not to permit the change to the settings (vehicle body settings) of the components of the vehicle body 3. Instead, the voice output device 91 may notify the rider R of this. In that case, the rider R may give the answer in the form of a voice by use of the voice input device 92. After the answer has been input, the process moves to step S5. In step S5 which is a first evaluation step, it is determined whether or not the change has been permitted, and the answer is sent from the vehicle body side wireless communication section 42 to the learning section 82 via the server side wireless communication section 81. After the answer has been sent to the learning section 82, the process moves to step S6.

In step S6 which is a second learning step, the learning section 82 learns the trend of evaluation for the proposed setting information. Specifically, in a case where the answer indicates permission of the change to the setting information, the learning section 82 learns that the rider R does not have a feeling of rejection to the change such as the proposed setting information, as the trend of evaluation, and actively proposes the change similar to the proposed setting information. On the other hand, in a case where the answer does not indicate permission of the change to the setting information, the learning section 82 learns that the rider R has a feeling of rejection to the change such as the proposed setting information, as the trend of evaluation, and does not propose the change similar to the proposed setting information. Note that the second learning step, the first learning step, the creating step, and a third learning step which will be described later are performed as a series of works in information processing such as the above-described neural network and Newton (registered mark), and these three steps are not clearly distinguished from each other. After the trend of evaluation has been learned, the process moves to step S7.

In step S7 which is a pre-setting evaluation determination step, it is determined whether or not the evaluation obtained in step S5 is high (good). In a case where the answer does not indicate permission of the change in step S5, the process returns to step S2, the learning section 82 learns the driving operation trend again and the creating section 84 creates the setting information again. On the other hand, in a case where the answer indicates permission of the change to the setting information in step S5, the process moves to step S8.

In step S8 which is a vehicle body setting change step, the vehicle body settings are changed based on the sent setting information. Specifically, the ECUs 71 to 75 obtain the sent setting information, and change the vehicle body settings based on the setting information. For example, in a case where the engine ECU 72 obtains the setting information, the engine ECU 72 changes a correspondence (setting) between the rotation amount of the throttle grip of the throttle device 31 and the opening/closing amount of the throttle valve of the throttle device 31, based on the setting information. This makes it possible to increase or reduce the opening/closing amount of the throttle valve of the throttle device 31 with respect to the rotation amount of the throttle grip, from the previous state. In a case where the suspension ECU 71 obtains the setting information, the suspension ECU 71 moves the suspensions 6, 16 based on the setting information to change the settings of the initial loads, the damping forces, the spring rates, the stroke lengths, or the like. Thus, in a case where the ECUs 71 to 75 obtain the setting information, the ECUs 71 to 75 change the vehicle body settings based on the setting information. After the vehicle body settings have been changed, the process moves to step S9.

In step S9 which is a notification step, the display device 25 displays that the vehicle body settings have been changed based on the setting information to notify the rider R of this change. Alternatively, the voice output device 91 may notify the rider R of this change. Since the rider R is notified of this change, the rider R is urged to become aware of how the changed vehicle body settings corresponding to the setting information is reflected in the traveling function of the motorcycle 2. In this way, the rider R is urged to become aware of a difference in the traveling behavior caused by changing the vehicle body settings. After the rider R has been notified of the change, the process moves to step S10. In step S10 which is a second evaluation step, the display device 25 displays question as to whether or not the changed vehicle body settings are adapted to a feeling of the rider R's driving operation. In response to this, the rider R gives the answer by use of the input device 45. This answer is sent from the vehicle body side wireless communication section 42 to the learning section 82 via the server side wireless communication section 81. After the answer has been sent to the learn section 82, the process moves to step S11 to learn the evaluation for the setting information.

In step S11 which is a third learning step, the learning section 82 learns whether or not the changed vehicle body settings are adapted to the feeling of the rider R's driving operation, i.e., the trend of the evaluation for the setting information, as in the second learning step. After the trend of the evaluation has been learned, the process moves to step S12. In step S12 which is a post-setting evaluation determination step, it is determined whether or not the evaluation obtained in step S10 is high (good). In a case where the answer indicates that the changed vehicle body settings are adapted to a feeling of the rider R's driving operation in step S10, the process returns to step S2 in a state in which the vehicle body settings are changed. On the other hand, in a case where the answer indicates that the changed vehicle body settings are not adapted to a feeling of the rider R's driving operation in step S10, the process moves to step S13. In step S13 which is a step of putting the vehicle body settings back to unchanged ones, the ECUs 71 to 75 put the vehicle body settings back to unchanged ones. After that, the process moves to step S2.

In the setting assist system 1 configured as described above, the learning section 82 learns the trends of the driving operation performed by the rider R, and the creating section 84 creates the information associated with the vehicle body settings based on the learning contents obtained by the learning. The display device 25 displays the created information. Based on the created information, the ECUs 71 to 75 and the electronic controllers 77, 78 change the settings of the vehicle body 3. In brief, the learning section 82 learns the driving operation trends for each rider R, and the creating section 84 creates the setting information based on the learning contents. This makes it possible to propose the setting information which reflects the driving operation trend unique to each rider R and reflect the setting information in the vehicle body settings. In a case where the driving operation information is obtained repeatedly and the learning is repeated, the learning contents can be familiarized. The detailed driving operation trends (e.g., habit or taste) of the rider R can be learned. The setting information which reflects the detailed driving operation trends can be proposed, or the detailed driving operation trends can be reflected in the setting of the vehicle body 3. In this way, the unique setting information according to the preference of each rider R can be proposed, or can be reflected in the settings of the vehicle body 3.

In the setting assist system 1 of the present embodiment, the rider R can send the evaluation for the setting information to the learning section 82, and the learning section 82 can learn the trend of the evaluation for the setting information. Therefore, the setting information corresponding to the evaluation can be created. In addition, the setting information adapted to the habit or taste of the rider R can be created. In the setting assist system 1, the driving operation trend can be divided into detained items with reference to the external information other than the driving operation information, the detailed items can be learned, and the setting information can be created based on the detailed learning contents. This makes it possible to create the setting information corresponding to the situation. Further, in the setting assist system 1, even in a case where a plurality of vehicle body settings mutually affect the driving operation feeling, the driving operation trends are learned and then the plurality of vehicle body settings can be changed simultaneously. By changing the plurality of vehicle body settings simultaneously in this way, the vehicle body behavior adapted to the habit or taste of the rider R can be obtained.

Furthermore, in the setting assist system 1 of the present embodiment, the learning section 82 and the creating section 84 which are required to have high processing abilities are disposed in the cloud server 3 which is distant from the vehicle body 3. In the motorcycle 2, many components are crammed in a narrow space, and the design flexibility of all of the components is not high. For this reason, it is difficult to use a processor with a high processing ability in the motorcycle 2. In a case where the processor with a high processing ability is mounted in the cloud server 37 which is higher in design flexibility of the components than the motorcycle 2, the design flexibility of the processor which implements the learning section 82 and the creating section 84 can be made high. As a result, the processor with a high processing ability can be used, and thus the learning section 82 and the creating section 84 can be implemented by this processor.

In the setting assist system 1 of the present embodiment, the learning command directing the learning is input by use of the input device 45. In response to the learning command, the learning section 82 begins to learn the driving operation trends and the creating section 84 creates the setting information. The rider R can make a choice, between a case where the learning of the driving operation trends is necessary and a case where the learning of the driving operation trends is unnecessary. In response to this choice, the learning section 82 determines whether or not to perform the learning. This can result in the learning according to the rider R's intention. In the setting assist system 1, the creating section 84 creates the changed information and the display device 25 displays the changed information. Thus, the rider R can know the changed items of the setting information and learn how the traveling function is changed according to the changed items. Note that in a case where the changed information contains the reason for changing the items, the creating section 84 well understands the meaning of the change in the traveling function resulting from the changed items.

In the setting assist system 1 of the present embodiment, the learning contents and the identification information are stored in the memory section 83. Therefore, even in a case where the rider R having the same identification information changes the vehicle, the learning contents obtained by the learning in the previous vehicle can be taken over to a new vehicle.

### Embodiment 2

A setting assist system 1A of Embodiment 2 has a configuration similar to that of the setting assist system 1 of Embodiment 1. Therefore, regarding the setting assist system 1A of Embodiment 2, constituents different from those of the setting assist system 1 of Embodiment 1 will be described and the same constituents will not be described in repetition.

The setting assist system 1A of Embodiment 2 includes a vehicle body side setting assist unit 35A, the server side setting assist unit 36, and a mobile terminal (portable terminal) 38. The vehicle body side setting assist unit 35A includes the driving operation information detecting section 41, the vehicle body side wireless communication section 42, the related information detecting section 43, and the actuator ECU 44. The mobile terminal 38 includes a terminal side communication section 47, a control section 48, and an input display section 49. The terminal side communication section 47 is able to perform a short distance wireless communication (e.g., Bluetooth (registered mark)) with the vehicle body side wireless communication section 42 and is wirelessly communicable with the server side wireless communication section 81 via a telephone line or the like. The terminal side communication section 47 is connected to the control section 48.

The control section 48 is configured to obtain the driving operation information and the related information from the driving operation information detecting section 41 and the related information detecting section 43 of the vehicle body side setting assist unit 35A, via the vehicle body side wireless communication section 42 and the terminal side communication section 47, and to send these information to the learning section 82 via the terminal side communication section 47 and the server side wireless communication section 81. The creating section 84 is configured to send the created setting information and changed information to the control section 48 via the server side wireless communication section 81 and the terminal side communication section 47. The input display section 49 is connected to the control section 48. The control section 48 is configured to display in the input display section 49 the setting information and the changed information having been created by the creating section 84.

The input display section 49 is configured to display whether or not to permit the change to the settings (vehicle body settings) of the components (constituents) of the vehicle body 3 based on the setting information. The input display section 49 has, for example, a touch panel input function. The rider R can input the answer to whether or not to permit the change to the vehicle body settings. When the answer is given, the control section 48 sends the answer to the learning section 82 via the terminal side communication section 47 and the server side wireless communication section 81. The learning section 82 is configured to learn the trend of evaluation for the setting information based on the answer. In a case where the answer indicates permission of the change to the settings, the control section 48 is configured to send the setting information to the bus 46 via the terminal side communication section 47 and the vehicle body side wireless communication section 42, and the ECUs 71 to 75 are configured to change the vehicle body settings based on the setting information.

The setting assist system 1A configured as described above performs the setting assist processing similar to that of the setting assist system 1A according to Embodiment 1, although the mobile terminal 38 exists between the vehicle body side setting assist unit 35A and the server side setting assist unit 36 regarding a communication. Upon input of the learning command, the setting assist processing is initiated, and the process moves to step S1. In step S1 which is an information obtaining step, the driving operation information and the related information are sent from the vehicle body side setting assist unit 35A to the learning section 82 of the server side setting assist unit 36 via the mobile terminal 38. In step S2 which is a first learning step, the learning section 82 learns the driving operation trends based on the driving operation information and the related information.

In step S3 which is a creating step, the creating section 84 creates the setting information and the changed information based on the learning contents obtained in step S2. In step S4 which is a display step, the setting information and the changed information having been created by the creating section 84 are sent from the server side wireless communication section 81 to the control section 48 via the terminal side communication section 47. The control section 48 displays the setting information and the changed information in the input display section 49, and request the rider R to give the answer to whether or not to permit the change to the settings.

In step S5 which is a first evaluation step, the control section 48 determines whether or not the answer has been input by the input display section 49, and sends the input answer from the terminal side communication section 47 to the learning section 82 via the server side wireless communication section 81. In a case where the answer indicates permission of the change to the settings, the setting information is sent from the terminal side communication section 47 to the bus 46 via the vehicle body side wireless communication section 42. In step S6 which is a second learning step, the learning section 82 learns the trend of evaluation for the proposed setting information based on the answer. In step S7 which is pre-setting evaluation determination step, it is determined whether or not the evaluation obtained in step S5 is high (good). In a case where the answer does not indicate permission of the change in step S5, the process returns to step S2. On the other hand, in a case where the answer indicates permission of the change in step S5, the process moves to step S8.

In step S8 which is a vehicle body setting change step, the actuator ECU 44 obtains the setting information flowing through the bus 46, and changes the vehicle body settings based on the setting information. After the vehicle body settings have been changed, the actuator ECU 44 sends the information indicative of completion of the change to the control section 48 via the vehicle body side wireless communication section 42 and the terminal side communication section 47. In step S9 which is a notification step, the display device 25 displays that the vehicle body settings have been changed, based on the information indicative of completion of the change to notify the rider R. In step S10 which is a second evaluation step, the control section 48 causes the input display section 49 to display the question as to whether or not the changed vehicle body settings are adapted to a feeling of the driving operation performed the rider R. Also, the control section 48 sends the answer to the learning section 82 via the terminal side communication section 47 and the server side wireless communication section 81.

In step S11 which is a third learning step, the learning section 82 learns the trend of evaluation for the setting information, based on the answer to whether or not the changed vehicle body settings are adapted to the feeling of the driving operation performed by the rider R. In step S12 which is a post-setting evaluation determination step, it is determined whether or not the evaluation obtained in step S10 is high (good). In a case where the answer indicates permission of the change, the process returns to step S2. On the other hand, in a case where the answer does not indicate permission of the change, the process moves to step S13. In step S13 which is a step of putting the vehicle body settings back to unchanged ones, the ECUs 71 to 75 put the vehicle body settings back to unchanged ones.

In the setting assist system 1A configured as described above, the setting information, the changed information, the questions, whether or not to permit the change to the settings, etc., are displayed on the input display section 49 of the mobile terminal 38. Therefore, it becomes possible to further reduce processing burden on the vehicle body side setting assist unit 35A. In addition, it becomes possible to ensure more flexibility of characters or images displayed on the input display section 49, than in a case where the information is displayed on the vehicle body 3.

The setting assist system 1A of Embodiment 2 can obtain advantages similar to those of the setting assist system 1 of Embodiment 1.

### Embodiment 3

A setting assist system 1B of Embodiment 3 has a configuration similar to that of the setting assist system 1 of Embodiment 1. Therefore, regarding the setting assist system 1B of Embodiment 3, components (constituents) different from those of the setting assist system 1 of Embodiment 1 will be described and the same constituents will not be described in repetition.

The setting assist system 1B of Embodiment 3 includes a vehicle body side setting assist unit 35B. Specifically, the vehicle body side setting assist unit 35B is configured to obtain the driving operation information and the related operation, learn the driving operation trends based on these information, and create the setting information based on the learning contents. The configuration of the vehicle body side setting assist unit 35B will be described below.

The vehicle body side setting assist unit 35B includes the driving operation information detecting section 41, the related information detecting section 43, the actuator ECU 44, the display device 25, the input device 45, the learning section 82, the memory section 83, and the creating section 84 which are connected to each other via the bus 46. The functional constituents have the same functions as those of the functional constituents included in the setting assist system 1 of Embodiment 1. The driving operation information detecting section 41 is configured to send the detected driving operation information to the learning section 82. The related information detecting section 43 is configured to send the detected related information to the learning section 82. The learning section 82 is configured to learn the driving operation trends based on the obtained driving operation information and the obtained related information. The memory section 83 is configured to store the learning contents or the like. The creating section 84 is configured to create the setting information and the changed information based on the learning contents. The display device 25 is configured to display the setting information, the changed information, the questions, whether or not to permit the change to the settings, or the like. The input device 45 can be operated to input the answer to the questions and the answer to whether or not to permit the change to the settings. The actuator ECU 44 is configured to change the vehicle body settings based on the setting information.

The setting assist system 1B configured as described above is configured to perform the setting assist processing by a procedure similar to that of the setting assist system 1 of Embodiment 1 except that the information is communicated via the bus 46 instead of the wireless communication sections 42, 81.

In the setting assist system 1B configured as described above, the setting assist is performed in the motorcycle 2 without use of the cloud server 37. Therefore, equipment cost can be reduced.

The setting assist system 1B of Embodiment 3 can obtain advantages similar to those of the setting assist system 1 of Embodiment 1.

### Other Embodiment

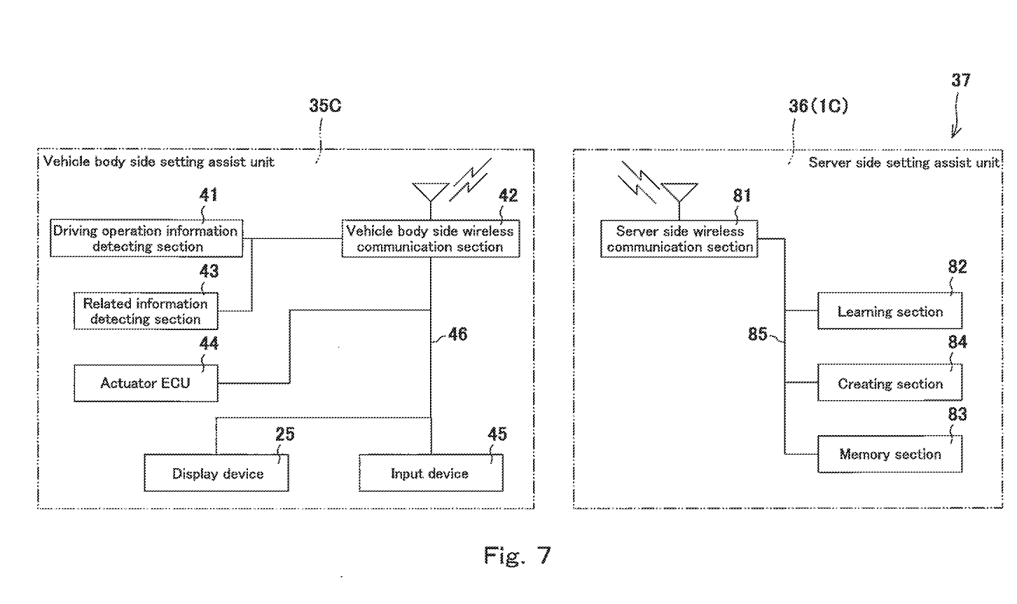

Although the setting assist system 1 of Embodiment 1 includes the vehicle body side setting assist unit 35 and the server side setting assist unit 36, the setting assist system 1 does not necessarily include both of the vehicle body side setting assist unit 35 and the server side setting assist unit 36. As shown in FIG. 7, only the cloud server 37 of the server side setting assist unit 36 may be a setting assist system 1C. The assisting the vehicle body settings of the motorcycle 2 can be performed by transmitting and receiving the driving operation information, the related information, the setting information, and the like between the setting assist system 1C and a vehicle body side device 35C (having the same configuration as that of the vehicle body side setting assist unit 35).

Although the setting assist systems 1, 1A, 1B of Embodiment 1 to Embodiment 3 include the sensors 51 to 59, 61 to 64, they may further include a pneumatic sensor attached on the front and rear wheels 4, 5, or a gyro sensor attached on the helmet of the rider R. The gyro sensor which will be described later can detect the direction of the rider R's face and the direction of the rider R's eyes. Error information output from the engine ECU 72 may be detected. The information detected by the pneumatic sensor, the information detected by the gyro sensor, and the error information are referred to as the external information, in a case where these information are sent to the learning section 82 and used for the learning. The voice information input by use of the voice input device 92, and healthy state of the rider R detected by a sensor may be obtained and referred to in the learning. Thus, various information may be referred to in the learning. The setting assist systems 1, 1A, 1B of Embodiment 1 to Embodiment 3 do not necessarily include all of the sensors 51 to 59, 61 to 64. The sensors may be chosen depending on the vehicle body settings which can be changed and the constituents of the motorcycle 2.

Although the setting assist systems 1, 1A, 1B of Embodiment 1 to Embodiment 3 are configured to obtain the trend of evaluation from the input to the input device 45, they may be configured to obtain the trend of evaluation from the answer input to the voice input device 92. In this case, the learning section 82 may convert the answer into text by voice recognition software (e.g., ViaVoice (registered mark) manufactured by IBM (registered mark), and determine whether the answer contains a positive or negative content by a text mining technique. The learning section 82 determines the trend of evaluation based on the content and propose the settings.

The learning section 82 may search the taste or the like of vehicle body settings based on frequency of an associated key word associated with the vehicle body settings contained in the text of the voice information formed by the voice recognition software. Further, by analyzing “modification(dependency)” between words, as well as the associated key word contained in the voice information, the operation, evaluation or the like with respect to the associated keyword can be understand at a higher level.

The setting assist systems 1, 1A, 1B of Embodiment 1 to Embodiment 3 may include a shifter ECU. The shifter ECU is connected to a gear shifter. In a case where a predetermined condition is met, the shifter ECU moves the gear shifter to shift a transmission gear position. The shifter ECU is capable of changing the settings (e.g., condition for shifting the transmission gear position) relating to an activation condition of the gear shifter based on the setting information.

Although the setting assist systems 1, 1A, 1B of Embodiment 1 to Embodiment 3, the ECUs 71 to 75 change the vehicle body settings based on the setting information, the ECUs 71 to 75 do not necessarily perform this. In the setting assist systems 1, 1A, 1B, the vehicle body settings may be manually changed. In this case, the display device 25 displays the setting information and the rider R and another person (e.g., mechanic) may change the vehicle body settings based on the setting information.

### REFERENCE CHARACTER LIST

1 setting assist system

2 motorcycle

3 vehicle body

6 front suspension

16 rear suspension

25 display device

31 throttle device

32 fuel injection device

33 ignition device

34 steering damper

41 driving operation information detecting section

42 vehicle body side wireless communication section

43 related information detecting section

44 actuator ECU

45 input device

47 terminal side communication section

49 input display section

81 server side wireless communication section

92 learning section

83 memory section

84 creating section

1. A setting assist system of a straddle vehicle configured to change a vehicle body setting which relates to a traveling function of a vehicle body, the setting assist system comprising:
a receiving section which receives driving operation information relating to a driving operation performed by a rider;
a learning section which learns a trend of the driving operation performed by the rider, based on the driving operation information received by the receiving section;
a creating section which creates setting information relating to the vehicle body setting based on a learning content obtained by learning by the learning section; and
an output section which outputs the setting information created by the creating section.

2. The setting assist system of the straddle vehicle according to claim 1,
wherein the receiving section receives an evaluation command indicating an evaluation for the setting information, the evaluation command being input by the rider,
wherein the learning section learns a trend of the evaluation command for the setting information, and
wherein the creating section creates the setting information based on the learning content including the learned trend of the evaluation command.

3. The setting assist system of the straddle vehicle according to claim 1,
wherein the receiving section receives external information other than the driving operation information, and
wherein the creating section creates the setting information based on the learning content and the external information.

4. The setting assist system of the straddle vehicle according to claim 1,
wherein the vehicle body is configured to change plural kinds of vehicle body settings, and
wherein the creating section creates the setting information relating to each of the plural kinds of vehicle body settings based on the learning content.

5. The setting assist system of the straddle vehicle according to claim 1,
wherein the receiving section receives a learning command directing learning of the trend of the driving operation performed by the rider, and
wherein the learning section is configured to determine whether or not to perform the learning, in response to the learning command received by the receiving section.

6. The setting assist system of the straddle vehicle according to claim 1, further comprising:
a detection/notification section which detects a change in the vehicle body setting and notifies the rider of the change.

7. The setting assist system of the straddle vehicle according to claim 1,
wherein the creating section stores the setting information previously created, and creates changed information of the setting information, the changed information indicating a change from the setting information previously created, and
wherein the output section outputs the setting information and the changed information which have been created by the creating section.

8. The setting assist system of the straddle vehicle according to claim 1, further comprising:
a memory section which stores the learning content obtained by the learning section and predetermined identification information so that the learning content corresponds to the predetermined identification information,
wherein the receiving section receives the driving operation information and the identification information, and
wherein the learning section obtains the learning content from the memory section based on the identification information received by the receiving section, and learns the trend of the driving operation performed by the rider, based on the obtained learning content and a sensor signal received by the receiving section.

9. The setting assist system of the straddle vehicle according to claim 1, wherein the learning section is disposed at a location that is distant from the vehicle body, and
wherein the receiving section receives the driving operation information sent from a transmission section which is provided at the vehicle body and is wirelessly communicable.

10. (canceled)

11. The setting assist system of the straddle vehicle according to claim 1, further comprising a memory section which contains therein setting rules defining the setting information to be created for the learning contents,
wherein the memory section contains the learning contents therein, and
wherein the creating section creates the setting information based on the learning contents and the setting rules.

12. A setting assist method of a straddle vehicle configured to change a vehicle body setting which relates to a traveling function of a vehicle body, the setting assist method comprising the steps of:
receiving driving operation information relating to a driving operation performed by a rider;
learning a trend of the driving operation performed by the rider, based on the driving operation information received in the step of receiving the driving operation information;
creating setting information relating to the vehicle body setting based on the trend of the driving operation learned in the step of learning the trend of the driving operation; and
outputting to the vehicle body, the setting information created in the step of creating the setting information.
